(19) United States
(12) Patent Application Publication
(10) Pub. No.: US 2018/0135816 A1
(43) Pub. Date: May 17, 2018

(54) ILLUMINATING UNIT AND PROJECTION DISPLAY APPARATUS

(71) Applicant: SONY CORPORATION, TOKYO (JP)

(72) Inventors: MASAHIRO ISHIGE, KANAGAWA (JP); MOTOSUKE OHMI, TOKYO (JP); IZUSHI KOBAYASHI, TOKYO (JP); YOSHIHISA SATO, SAITAMA (JP)

(21) Appl. No.: 15/564,005

(22) PCT Filed: Mar. 28, 2016
(86) PCT No.: PCT/JP2016/059876

§ 371 Date: Oct. 3, 2017

(30) Foreign Application Priority Data
Apr. 14, 2015 (JP) 2015-082517

(51) Int. Cl. F21S 2/00; F21V 29/502; F21V 29/51; F21V 29/70; F21V 9/08; F21V 9/30; F21V 9/40; G02F 1/13; G02B 5/30

(52) U.S. Cl. CPC F21S 2/00; F21V 29/502; F21V 29/51; F21V 29/70; G03B 33/12; F21V 9/30; F21V 9/40; G02F 1/13; G02B 5/3025; F21V 9/08

(57) ABSTRACT

An illuminating unit according to an embodiment of the disclosure includes: a mounting member; a light source section that is aligned on the mounting member, and has one or more solid-state light sources that emit light in a predetermined wavelength band; and an optical conversion section that is coupled to the light source section, and converts outgoing light emitted from the solid-state light source into light in a wavelength band that is different from the wavelength band of the outgoing light.

### TECHNICAL FIELD

The disclosure relates to an illuminating unit that uses a solid-state light-emitting device such as a laser diode (LD), and to a projection display apparatus that includes such an illuminating unit.

### BACKGROUND ART

In recent years, a product has increased in number that adopts a solid-state light-emitting device such as a light-emitting diode (LED) and a laser diode (LD) instead of a currently-available high-pressure mercury lamp, a xenon lamp, or any other equivalent lamp for a light source in use for a projector, or any other equivalent apparatus for presentation or digital cinema. The solid-state light-emitting device such as the LED is more advantageous than a discharge lamp in terms of not only size and power consumption but also high reliability. In particular, to achieve further enhanced luminance and lowered power consumption, it is effective to improve the light use efficiency with use of the LED that serves as a point light source.

For example, PTL 1 discloses a projection display apparatus that uses an LD as a light source. In the projection display apparatus, a fluorescent wheel with a fluorescent body applied thereon is irradiated with a blue laser beam emitted out of the LD as excitation light. The fluorescent body that is formed on the fluorescent wheel is excited by the blue laser beam, resulting in, for example, yellow fluorescent light being emitted out. The yellow fluorescent light and the blue laser beam are synthesized to generate white light.

### CITATION LIST

### Patent Literature

[PTL 1] Japanese Unexamined Patent Application Publication No. 2014-92599

### SUMMARY OF THE INVENTION

In such a projection display apparatus, a focus position of the excitation light to be applied to the fluorescent wheel is important, and thus, it is desired to improve the positional accuracy between the fluorescent body that is formed as a film on the fluorescent wheel and a light-collecting lens that focuses the excitation light onto the fluorescent body. In the projection display apparatus, however, because it is necessary to suppress rise in temperature in consideration of temperature resistance in optical conversion efficiency of the fluorescent body itself, and thermal resistance of a binder, etc. for forming the fluorescent body on a base material, optical components such as the fluorescent wheel and the light-collecting lens have been attached to a cooling device as a common practice. This has been disadvantageous in that alignment between a light source and the fluorescent wheel involves a difficulty.

Accordingly, it is desirable to provide an illuminating unit that makes it possible to improve the reliability, and a projection display apparatus that uses such an illuminating unit.

An illuminating unit according to one embodiment of the disclosure includes: a mounting member; a light source section that is aligned on the mounting member, and has one or more solid-state light sources that emit light in a predetermined wavelength band; and an optical conversion section that is coupled to the light source section, and converts outgoing light emitted from the solid-state light source into light in a wavelength band that is different from the wavelength band of the outgoing light.

A projection display apparatus according to one embodiment of the disclosure includes: an illuminating optical system; an image-generating optical system that generates image light by modulating light from the illuminating optical system on the basis of an incoming image signal; and a projecting optical system that projects the image light generated in the image-generating optical system. The illuminating optical system mounted on the projection display apparatus has components same as those of the foregoing illuminating unit according to the disclosure.

In the illuminating unit and the projection display apparatus according to the respective embodiments of the disclosure, the optical conversion section that converts the outgoing light emitted from the solid-state light source into the light in the wavelength band that is different from the wavelength band of the outgoing light is coupled to the light source section that is aligned on the mounting member, and has the one or more solid-state light sources that emit light in the predetermined wavelength band. This improves the positional accuracy between the light source section and the optical conversion section.

According to the illuminating unit and the projection display apparatus of the respective embodiments of the disclosure, the optical conversion section that converts the outgoing light emitted from the light source section into the light in the wavelength band that is different from the wavelength band of the outgoing light is coupled to the light source section that is aligned on the mounting member. This makes it possible to improve the positional accuracy between the light source section and the optical conversion section, and to provide the illuminating unit and the projection display apparatus that are highly reliable. It is to be noted that effects described above are not necessarily limitative, and any of effects described in the disclosure may be provided.

### BRIEF DESCRIPTION OF DRAWINGS

FIG. 1 is a perspective view of an external appearance of a main part that configures an illuminating unit according to one embodiment of the disclosure.

FIG. 2 is a schematic diagram illustrating an example of a specific configuration of the illuminating unit illustrated in FIG. 1.

FIG. 3 is a simplified diagram illustrating a configuration of the illuminating unit illustrated in FIG. 1.

FIG. 4A is a planar schematic diagram of a fluorescent wheel illustrated in FIG. 3.

FIG. 4B is a cross-sectional schematic diagram of the wheel in the form illustrated in FIG. 4A.

FIG. 5 is a perspective view of a configuration of a wheel holder illustrated in FIG. 1.

FIG. 6 is a simplified diagram illustrating a configuration example of a projection display apparatus that includes the illuminating unit illustrated in FIG. 1.

### MODES FOR CARRYING OUT THE INVENTION

Hereinafter, one embodiment of the disclosure is described in detail with reference to the drawings. It is to be noted that the description is given in the following order.

1. Embodiment (an illuminating unit that couples a wheel holder to a light source chassis)
2. Application Example (a projection display apparatus)

### 1. Embodiment

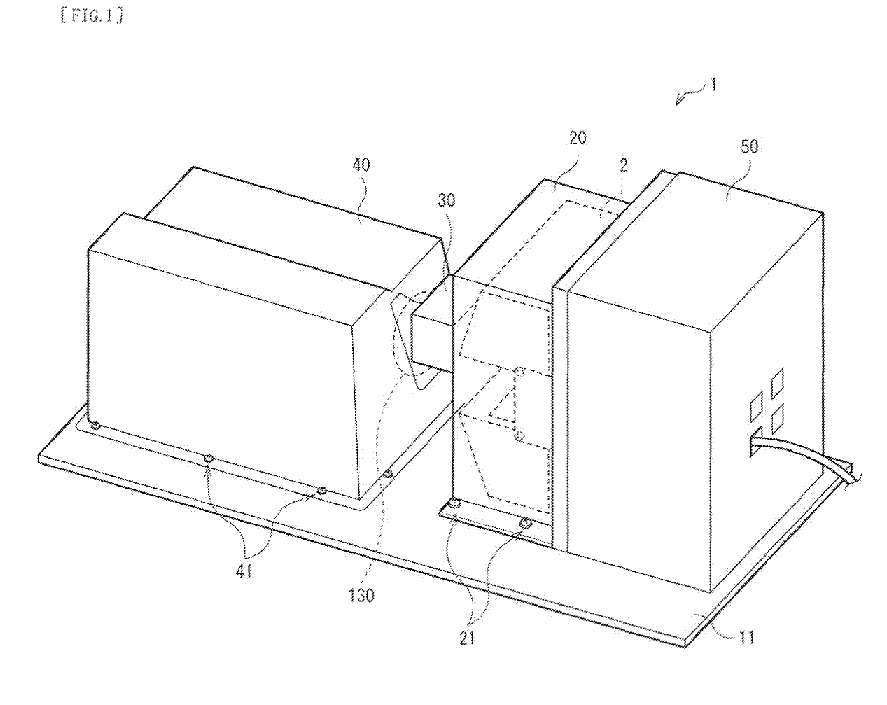

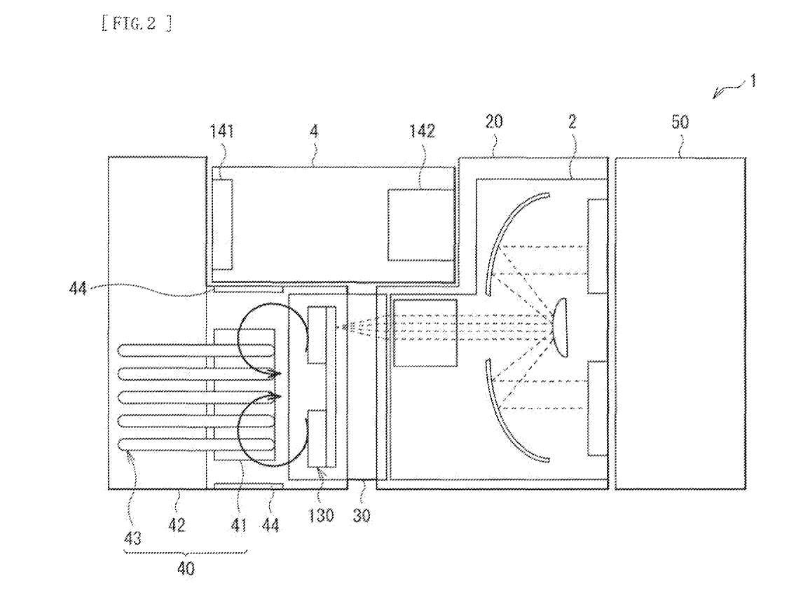

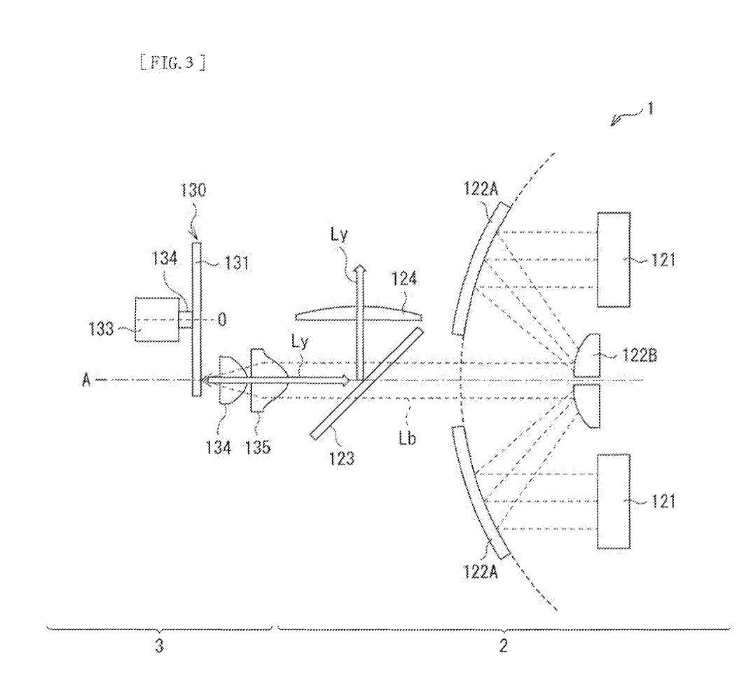

FIG. 1 illustrates an external appearance of a main part that configures an illuminating unit (an illuminating unit 1) according to one embodiment of the disclosure, and FIG. 2 schematically illustrates an example of a specific configuration of the illuminating unit 1. The illuminating unit 1 is used, for example, as an illuminating optical system of a projection display apparatus (a projector 100) to be described later. The illuminating unit 1 has, for example, a light source 121 with a plurality of LDs disposed thereon as a solid-state light source, and a fluorescent wheel 130 that converts the light outgoing from the light source 121 into light in a different wavelength band (see FIG. 3). The light source 121 and the fluorescent wheel 130 are housed in a light source chassis 20 and a wheel holder 30, respectively.

In the present embodiment, in the illuminating unit 1, the light source chassis 20 in which a light source section 2 is housed is aligned on a mounting member (a plate-like member 11), and is fixed with, for example, screws 21, and the wheel holder 30 in which the fluorescent wheel 130 is housed is coupled to the light source chassis 20 in an integrated manner, as illustrated in FIG. 1. On the plate-like member 11, a cooling chassis 40 in which a circulating cooling device (for example, heat sinks 41 and 42, and a heat exchanger 43) that cools the fluorescent wheel 130 is housed is placed. As with the light source chassis 20, the cooling chassis 40 is aligned on the plate-like member 11, and is fixed with screws 41, or any other fixture. In addition, a heat sink 50 that cools light sources, or any other component part may be placed on the plate-like member 11.

FIG. 3 is a simplified diagram illustrating an example of a configuration of the light source section 2 and an optical conversion section 3 according to the present embodiment. The light source section 2 has, for example, the light source 121 including the plurality of LDs, a variety of optical members, etc. Specifically, the light source section 2 has, for example, light-collecting mirrors 122A and 122B for focusing light (a blue laser beam Lb) that is emitted out of the light source 121 onto the fluorescent wheel 130, a dichroic mirror 123 that selectively reflects light (yellow light Ly) that is emitted out of the optical conversion section 3, for example, on the side of a light source section 4, and a light-collecting lens 124. It is to be noted that the light source section 4 houses, for example, a light source 141 that oscillates the blue laser beam Lb, a dichroic mirror 142, etc., as with the light source 121 which will be described later.

The light source 121 is a blue laser light source that is able to oscillate the blue laser beam Lb having a peak wavelength of emission intensity within the wavelength range of 400 nm to 500 nm, for example. This blue laser light source corresponds to a single or a plurality of solid-state light sources that emit light in a predetermined wavelength band. Instead of the LDs, any other light source such as LEDs may be used for the light source 121. Further, the predetermined wavelength band is not limited to the blue light having the peak wavelength of the emission intensity within the wavelength range of 400 nm to 500 nm as described above.

The light-collecting mirror 122A has a concave reflection surface that substantially parallelizes a bundle of ray of the blue laser beams Lb emitted out of the plurality of LDs that are disposed on the light source 121, and focuses the bundle of ray onto the light-collecting mirror 122B. The light-collecting mirror 122B reflects the blue laser beams Lb collected by the light-collecting mirror 122A to the fluorescent wheel 130.

The dichroic mirror 123 has a property of selectively reflecting color light in a predetermined wavelength band, and transmitting light in any other wavelength band. Specifically, for example, the blue laser beam Lb that is emitted out of the light source 121 to travel through the light-collecting mirrors 122A and 122B passes through the dichroic mirror 123 to be applied to a fluorescent layer 132 that is formed on the fluorescent wheel 130 to be described later, leading to a fluorescent body being excited. The excited fluorescent body outputs light in a wavelength band including a wavelength band range from a red wavelength band to a green wavelength band (that is, the yellow light Ly), for example. The yellow light Ly is reflected by the dichroic mirror 123 toward the side of the light-collecting lens 124.

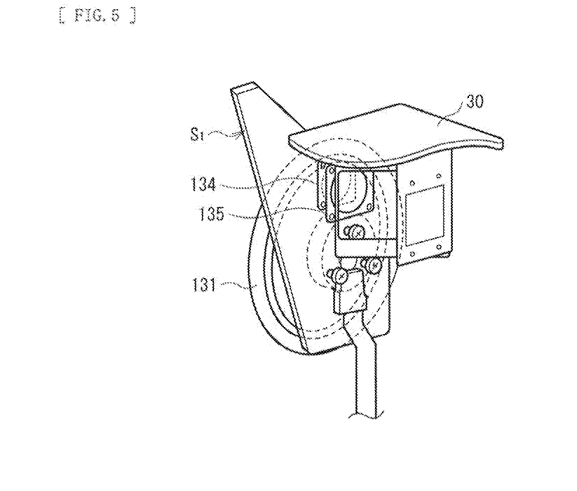

In addition to the fluorescent wheel 130, the optical conversion section 3 has light-collecting lenses 134 and 135 that focus the light incoming from the light source section 2 onto a predetermined position of the fluorescent wheel 130. The fluorescent wheel as well as the light-collecting lenses 134 and 135 are attached to the wheel holder 30 as illustrated in FIG. 5, for example. The wheel holder 30 includes, for example, an upper chassis (the wheel holder 30 illustrated in FIG. 5) to which the light-collecting lenses 134 and 135, etc. are mounted, and a lower chassis (not illustrated in the diagram) that covers side surfaces and bottoms of the light-collecting lenses 134 and 135, etc. In the present embodiment, for example, the lower chassis is coupled on the side of the light source chassis 20, and the wheel holder 30 having an external appearance of a cuboid shape illustrated in an example in FIG. 1 is configured by fitting the upper chassis including a fluorescent wheel 131, etc. to the lower chassis.

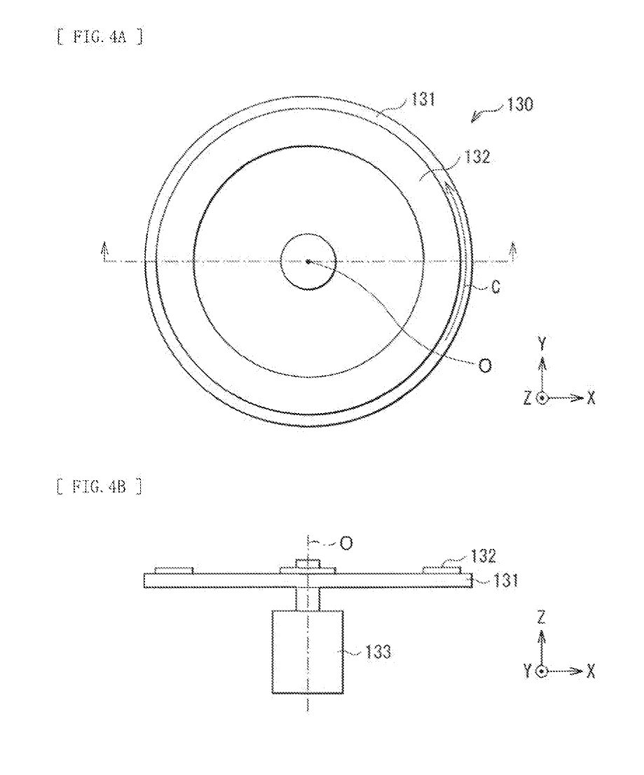

The fluorescent wheel 130 has a disk-shaped substrate 131, and the fluorescent layer 132 that is provided on the substrate 131, as illustrated in FIGS. 4A and 4B. The substrate 131 is rotatable by a motor 133 in a direction of an arrow C around a rotation axis O that is defined as a normal line passing through the center of the substrate 131.

The fluorescent layer 132 is excited by the light applied from the light source 121 to emit fluorescent light having a wavelength band that is different from the wavelength band of the exciting light. In the present embodiment, the fluorescent layer 132 includes a fluorescent substance that is excited by the blue laser beam Lb having a center wavelength of about 445 nm to emit fluorescent light, and converts the blue laser beam Lb applied from the light source 121 into the yellow light Ly to output the resultant light.

As the fluorescent substance included in the fluorescent layer 132, for example, a YAG (yttrium aluminum garnet)-based fluorescent body is used. It is to be noted that a kind of the fluorescent substance, a wavelength band of light to be excited, and a wavelength band of visible light to be generated by excitation are not limitative.

In the optical conversion section 3, a focus position on the fluorescent layer 132 that is irradiated with the blue laser beam Lb is moved relatively by rotation of the substrate 131 by the motor 133. This makes it possible to avoid degradation caused by application of exciting light to the same position on the fluorescent layer 132 for a long period of time.

The yellow light Ly emitted out of the fluorescent layer 132 is reflected toward the side of the light source section 2, and is reflected to the side of the light-collecting lens 124 by the dichroic mirror 123 that is disposed between the fluorescent wheel 130 and the light source 121, etc.

The light source section 2 and the optical conversion section 3 are adjusted in such a manner that an optical axis A of the blue laser beam Lb to be emitted out of the light source section 2 and the rotation axis O of the fluorescent wheel 130 become parallel to each other, as illustrated in FIG. 3. Further, the rotation axis O of the fluorescent wheel 130 is disposed at a different position from the optical axis A to allow a predetermined position of the fluorescent layer 132 to be located on the optical axis A. In other words, the fluorescent wheel 130 is disposed in such a manner that a focus position of the blue laser beam Lb that is collected by the light-collecting lenses 134 and 135 coincides with the predetermined position on the fluorescent layer 132. On the fluorescent layer 132 that is irradiated with the blue laser beam Lb, the fluorescent body is excited by the blue laser beam Lb, and yellow fluorescent light (the yellow light Ly) including a wavelength band range from the red wavelength band to the green wavelength band is emitted out. The yellow light Ly travels straight in a direction opposite to the blue laser beam Lb in parallel with the optical axis A to pass through the light-collecting lenses 134 and 135, and is reflected by the dichroic mirror 123 in a vertical direction relative to the optical axis A to enter the light-collecting lens 124. Further, for example, the yellow light Ly enters the light source section 4 to be synthesized with the blue laser beam Lb that is oscillated by the light source 141 housed in the light source section 4. Specifically, the yellow light Ly that enters the light source section 4 through the light-collecting lens 124 is oscillated by the light source 141, and is synthesized with the blue laser beam Lb that is reflected by the dichroic mirror 142 in the same direction as a travelling direction of the yellow light Ly to become white light Lw.

To improve the light use efficiency in the illuminating unit 1 that is configured in such a manner, alignment between the light source section 2 and the optical conversion section 3, in concrete terms, the alignment among the light source 121 that outputs the blue laser beam Lb as exciting light of the fluorescent body, the fluorescent layer 132 that is provided on the fluorescent wheel 130 that is irradiated with the blue laser beam Lb, and the light-collecting lenses 134 and 135 that focus the blue light onto any position, that is, the predetermined position of the fluorescent layer 132 on the fluorescent wheel 130 becomes important.

Meanwhile, on the fluorescent wheel 130, a position that is irradiated with the exciting light produces heat as a result of application of the exciting light, resulting in the substrate 131 and air inside the wheel holder 30 being also heated. Heat generation of the fluorescent body, and heating of the substrate 131 and the air inside the wheel holder 30 have a significant influence on the optical conversion efficiency of the fluorescent body, and the thermal resistance of a binder, etc. for forming the fluorescent layer 132 on the substrate 131, and therefore, it is necessary to cool the position that is irradiated with the exciting light, and the inside of the wheel holder 30. Consequently, in a general illuminating unit, cooling members such as a heat exchanger has been housed along with a fluorescent wheel inside a wheel holder, and further, the wheel holder has been coupled to a cooling device that is assembled separately.

In the meantime, in recent years, it has been desired to further enhance the luminance in a projection display apparatus, and exciting light having greater intensity has been used. Since the amount of heat generation of a fluorescent wheel increases in proportion to the intensity of the exciting light to be applied, a cooling device directed to cooling the fluorescent wheel tends to become larger in size with an increase in the luminance of the projection display apparatus. Such a projection display apparatus has been disadvantageous in that the alignment between the fluorescent wheel and a light source has a difficulty.

On the contrary, in the present embodiment, the wheel holder 30 including the fluorescent wheel 130 is coupled to the light source chassis 20 housing the light source section 2 that is aligned on the plate-like member 11. This makes it possible to easily and accurately perform the alignment between the light source section 2 and the optical conversion section 3, in concrete terms, the alignment of a series of optical systems from the light source 121 to the fluorescent wheel 130.

It is to be noted that the cooling chassis 40 housing the cooling device that cools the fluorescent wheel 130, and the wheel holder 30 are not fixed particularly by screwing or any other means, and are simply brought into contact with each other. However, at the optical conversion section 3, dust in the air may be burnt and attached to the surface of the fluorescent layer due to exciting light, which may raise the possibility of deterioration in the optical conversion efficiency. Therefore, the cooling chassis 40 and the wheel holder 30 preferably come in contact with each other without any gap. For example, as illustrated in FIG. 5, by configuring a portion 51 of the wheel holder 30 that is a location coming in contact with the cooling chassis 40 in a tilted shape, it is possible to fit the wheel holder 30 and the cooling chassis 40 to each other without any gap. Further, a buffer member may be disposed between the cooling chassis 40 and the wheel holder 30. This improves the sealing performance, thereby allowing for prevention of intrusion of dust, etc. Examples of the buffer member include a cushion and a pad.

Further, for the wheel holder 30, a dust attraction pad 44 that absorbs dust, etc. may be disposed in the inside thereof. As a position where the dust attraction pad 44 is disposed, for example, as indicated with arrows in FIG. 2, the dust attraction pad 44 is preferably provided in the vicinity of the upstream area of an airstream arising from rotation of the fluorescent wheel 130. Specifically, for example, the dust attraction pad 44 is preferably provided on a sidewall inside the cooling chassis, or any other equivalent location.

It is to be noted that the wheel holder 30 and the cooling chassis 40 may be coupled to each other unless such coupling causes any failure in the alignment of the series of the optical systems from the light source 121 to the fluorescent wheel 130.

As described above, in the illuminating unit 1 in the present embodiment, the wheel holder 30 including the fluorescent wheel 130 is coupled to the light source chassis 20 that houses the light source section 2. This makes it possible to easily and accurately perform the alignment among the various optical members such as the light source 121, the fluorescent wheel 130, as well as the light-collecting lenses 134 and 135 that configure the light source section 2 and the optical conversion section 3. Further, the improvement of the positional accuracy of the various optical members allows the optical conversion efficiency (light use efficiency) to be raised. This makes it possible to provide the highly-reliable illuminating unit 1.

### 2. Application Example

The description is provided below of a projection display apparatus. Here, as an example of the projection display apparatus, the description is provided by referring to, as an example, a projector 100 that incorporates the illuminating unit 1 mentioned in the above-described embodiment.

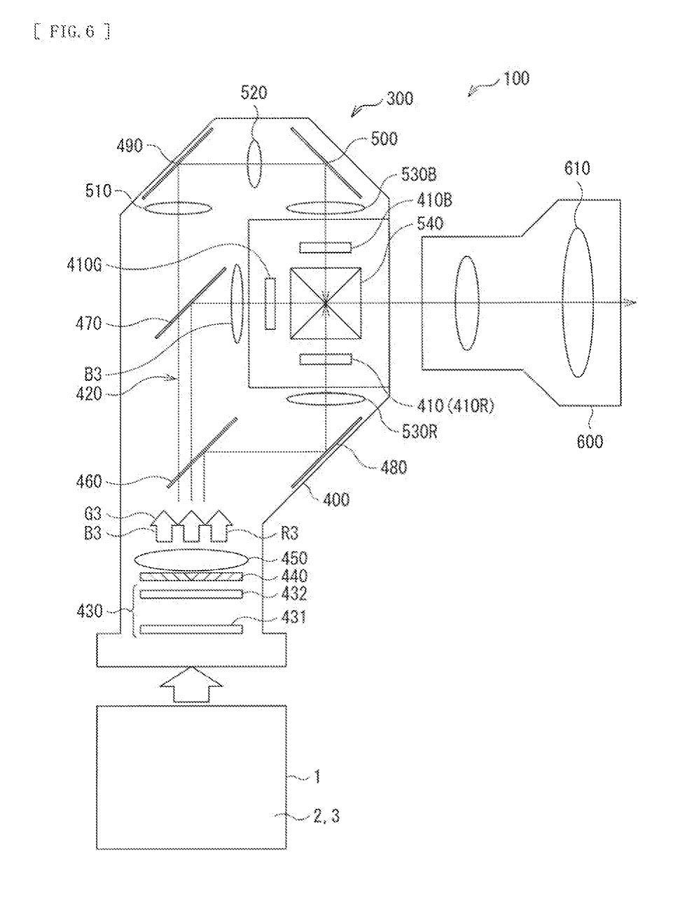

FIG. 6 schematically illustrates an example of a configuration of a projector. A projector 300 has the illuminating unit 1 according to the technology, an image-generating system 400, and a projecting optical system 600. The image-generating system 400 has an image-generating device 410 that generates images on the basis of applied light, and an illuminating optical system 420 that irradiates the image-generating device 410 with the light outgoing from the illuminating unit 1. The projecting optical system 600 projects the images generated by the image-generating device 410.

As illustrated in FIG. 6, the image-generating system 400 has, for example, an integrator device 430, a polarization conversion device 440, and a light-collecting lens 450. The integrator device 430 includes a first fly-eye lens 431 having a plurality of microlenses that are two-dimensionally disposed, and a second fly-eye lens 432 having a plurality of microlenses that are disposed in a manner of corresponding to the respective microlenses of the first fly-eye lens 431 one by one.

The light (parallel light) entering the integrator device 430 from the illuminating unit 1 is divided into a plurality of bundles of ray by the microlenses of the first fly-eye lens 431 to be imaged respectively by the corresponding microlenses in the second fly-eye lens 432. Each of the microlenses of the second fly-eye lens 432 functions as a secondary light source, and irradiates the polarization conversion device 440 with a plurality of parallel light beams with uniform luminance as incoming light.

As a whole, the integrator device 430 has a function of adjusting the entrance light to be applied to the polarization conversion device 440 from the illuminating unit 1 into a uniform luminance distribution.

The polarization conversion device 440 has a function of uniforming polarization states of the entrance light incoming through the integrator device 430, etc. For example, the polarization conversion device 440 emits output light including blue light B3, green light G3, and red light R3 through the light-collecting lens 450, etc., that are disposed on the output side of the illuminating unit 1.

The illuminating optical system 420 includes dichroic mirrors 460 and 470, mirrors 480, 490, and 500, relay lenses 510 and 520, field lenses 530R, 530G and 530B, liquid crystal light valves 410R, 410G and 410B that serve as image-generating devices, and a dichroic prism 540.

The dichroic mirrors 460 and 470 have the property of selectively reflecting color light in a predetermined wavelength band, and transmitting light in any other wavelength band. With reference to FIG. 6, for example, the dichroic mirror 460 reflects the red light R3 selectively. The dichroic mirror 470 reflects the green light G3 selectively out of the green light G3 and the blue light B3 that pass through the dichroic mirror 460. The remaining blue light B3 passes through the dichroic mirror 470. As a result, the light (white light) that is emitted out of the illuminating unit 1 is separated into a plurality of color light beams of different colors.

The separated red light R3 is reflected by the mirror 480, and is parallelized by passing through the field lens 530R, and thereafter enters the liquid crystal light valve 410R for modulation of the red light. The green light G3 is parallelized by passing through the field lens 530G and thereafter enters the liquid crystal light valve 410G for modulation of the green light. The blue light B3 passes through the relay lens 510 to be reflected by the mirror 490, and further passes through the relay lens 520 to be reflected by the mirror 500. The blue light B3 that is reflected by the mirror 500 is parallelized by passing through the field lens 530B, and thereafter enters the liquid crystal light valve 410B for modulation of the blue light.

The liquid crystal light valves 410R, 410G and 410B are electrically coupled to an unillustrated signal source (for example, a PC, etc.) that provides image signals including image information. The liquid crystal light valves 410R, 410G and 410B modulate entrance light for each of pixels on the basis of a delivered image signal of each color to generate a red image, a green image, and a blue image, respectively. The modulated light of each color (formed images) enters the dichroic prism 540 to be synthesized. The dichroic prism 540 superimposes to synthesize light of each color incoming from three directions, and outputs the resultant light toward the projecting optical system 600.

The projecting optical system 600 has a plurality of lenses 610, etc., and irradiates an unillustrated a screen with the light that is synthesized by the dichroic prism 540. This leads to display of full-color images.

It is to be noted that the technology is not limited to the above-described embodiment, but various embodiments may be achieved.

In the projector 300 illustrated in FIG. 6, the image-generating system 400 that is configured with use of a transmissive liquid crystal panel is described. However, the use of a reflective liquid crystal panel makes it also possible to configure the image-generating system. As the image-generating device, a digital micromirror device (DMD), etc. may be used alternatively. Further, instead of the dichroic prism 540, a polarization beam splitter (PBS), a color synthesizing prism that synthesizes image signals of respective RGB colors, a TIR (Total Internal Reflection) prism, or any other equivalent element may be used.

Further, in the above-described embodiment, the description is provided using a plate-shaped member (the plate-like member 11) as a mounting member of the light source chassis 20 and the cooling chassis 40. However, as long as a mounting member allows mounting of the light source chassis 20 and the cooling chassis 40, any shape is acceptable. For example, the light source chassis 20 and the cooling chassis 40 may be fixed on respective two rod-shaped members. Further, the light source chassis 20 and the cooling chassis 40 may not necessarily be fixed on the same member.

Moreover, it is enough that the cooling chassis 40 is coupled to the light source chassis 20 with the wheel holder 30 in between. The light source chassis 20 and the cooling chassis 40 may not necessarily be disposed with the wheel holder 30 interposed between, as illustrated in FIG. 1. In addition, in the above-described embodiment, the description is provided by taking as a specific example each of the component parts (optical systems) of the illuminating unit. However, it is not necessary to provide all of the component parts, and further, any other component parts may be further provided.

In addition, in the above-described embodiment, the description is provided by taking as an example the display apparatus such as a projection type as an application of the illuminating unit of the disclosure; however, the application is not limited thereto. For example, the illuminating unit of the disclosure is also applicable to an exposure apparatus such as a stepper.

Further, as the projection display apparatus according to the technology, an apparatus other than the above-described projector may be configured. Additionally, the illuminating unit according to the technology may be used for an apparatus that is not the projection display apparatus.

It is to be noted that the technology may be also configured as follows.

(1) An illuminating unit including:

a mounting member;

a light source section that is aligned on the plate-like member, and has one or more solid-state light sources that emit light in a predetermined wavelength band; and

an optical conversion section that is coupled to the light source section, and is excited by the outgoing light emitted from the solid-state light source to emit light in a wavelength band that is different from the wavelength of the outgoing light.

(2) The illuminating unit according to (1), further including a cooling section that is aligned on the plate-like member, and cools the optical conversion section.
(3) The illuminating unit according to (2), in which the optical conversion section is disposed between the light source section and the cooling section.
(4) The illuminating unit according to (2) or (3), in which the cooling section is coupled to the light source section with the optical conversion section in between.
(5) The illuminating unit according to any one of (2) to (4), in which the optical conversion section is in contact with the cooling section with a buffer member in between.
(6) The illuminating unit according to any one of (2) to (5), in which the optical conversion section is not fixed to the cooling section.
(7) The illuminating unit according to any one of (1) to (6), in which the optical conversion section has a fluorescent body that is excited by the outgoing light emitted from the solid-state light source to emit light in a wavelength band that is different from the wavelength of the outgoing light; and a base that supports the fluorescent body, the base being orthogonal to a direction of an optical axis of the outgoing light, and rotating around a predetermined rotation axis.
(8) The illuminating unit according to any one of (1) to (7), in which the mounting member is a plate-shaped member.
(9) The illuminating unit according to any one of (1) to (8), in which the solid-state light source is a laser light source that emits a laser beam as the outgoing light.
(10) The illuminating unit according to (9), in which the laser light source emits a blue laser beam.
(11) A projection display apparatus including:

an illuminating optical system;

an image-generating optical system that generates image light by modulating light from the illuminating optical system on the basis of an incoming image signal; and

a projecting optical system that projects the image light generated in the image-generating optical system,

the illuminating optical system including

a mounting member,

a light source section that is aligned on the plate-like member, and has one or more solid-state light sources that emit light in a predetermined wavelength band, and

an optical conversion section that is coupled to the light source section, and is excited by the outgoing light emitted from the solid-state light source to emit light in a wavelength band that is different from the wavelength of the outgoing light.

This application claims the priority on the basis of Japanese Patent Application No. 2015-082517 filed on Apr. 14, 2015 in Japan Patent Office, the entire contents of which are incorporated in this application by reference.

Those skilled in the art could assume various modifications, combinations, subcombinations, and changes in accordance with design requirements and other contributing factors. However, it is understood that they are included within a scope of the attached claims or the equivalents thereof.

1. An illuminating unit comprising:
a mounting member;
a light source section that is aligned on the mounting member, and has one or more solid-state light sources that emit light in a predetermined wavelength band; and
an optical conversion section that is coupled to the light source section, and converts outgoing light emitted from the solid-state light source into light in a wavelength band that is different from the wavelength band of the outgoing light.

2. The illuminating unit according to claim 1, further comprising a cooling section that is aligned on the mounting member, and cools the optical conversion section.

3. The illuminating unit according to claim 2, wherein the optical conversion section is disposed between the light source section and the cooling section.

4. The illuminating unit according to claim 2, wherein the cooling section is coupled to the light source section with the optical conversion section in between.

5. The illuminating unit according to claim 2, wherein the optical conversion section is in contact with the cooling section with a buffer member in between.

6. The illuminating unit according to claim 2, wherein the optical conversion section is not fixed to the cooling section.

7. The illuminating unit according to claim 1, wherein the optical conversion section has a fluorescent body that is excited by the outgoing light emitted from the solid-state light source to emit light in a wavelength band that is different from the wavelength of the outgoing light; and a base that supports the fluorescent body, the base being orthogonal to a direction of an optical axis of the outgoing light, and rotating around a predetermined rotation axis.

8. The illuminating unit according to claim 1, wherein the mounting member is a plate-shaped member.

9. The illuminating unit according to claim 1, wherein the solid-state light source is a laser light source that emits a laser beam as the outgoing light.

10. The illuminating unit according to claim 9, wherein the laser light source emits a blue laser beam.

11. A projection display apparatus comprising:
an illuminating optical system;
an image-generating optical system that generates image light by modulating light from the illuminating optical system on a basis of an incoming image signal; and
a projecting optical system that projects the image light generated in the image-generating optical system,
the illuminating optical system including
a mounting member,
a light source section that is aligned on the mounting member, and has one or more solid-state light sources that emit light in a predetermined wavelength band, and
an optical conversion section that is coupled to the light source section, and converts outgoing light emitted from the solid-state light source into light in a wavelength band that is different from the wavelength band of the outgoing light.
